(19) United States
(12) Patent Application Publication
(10) Pub. No.: US 2012/0223021 A1
(43) Pub. Date: Sep. 6, 2012

(54) SYSTEM AND METHOD FOR TREATING WASTE

(76) Inventor: Dominic O. Rathallaigh, Ballyhaunis (IE)

(21) Appl. No.: 13/040,101

(22) Filed: Mar. 3, 2011

(51) Int. Cl. C02F 1/52; B01D 24/00

(52) U.S. Cl. 210/710; 210/189

(57) ABSTRACT

A system and method for removing water from sludge including mixing a blending material into the sludge and compressing the mixture. Additional pre and post compression steps are disclosed. Examples of specific blending materials and methods for their use are disclosed.

### TECHNICAL FIELD

The present disclosure relates generally to methods and systems for treating waste. In particular, the present disclosure relates to a system and method for de-watering sludge.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a schematic drawing of a waste treatment system;

FIG. 2 is a flow diagram of a method for treating waste;

FIG. 3 is a cut-away front elevation view of one embodiment of a compression apparatus;

FIG. 4A is a perspective view of one embodiment of an upper plate for a compression apparatus;

FIG. 4B is a cut-away front elevation view of the upper plate of FIG. 4A;

FIG. 5 is a cut-away front elevation view of an embodiment of a compression apparatus which includes sidewalls;

FIG. 6 is an exploded perspective view of certain components of a compression apparatus.

### DETAILED DESCRIPTION

It will be readily understood that the components and steps of the embodiments as generally described and illustrated in the figures herein could be arranged, performed, or designed in a wide variety of different configurations. Thus, the following more detailed description of various embodiments, as represented in the figures, is not intended to limit the scope of the disclosure, but is merely representative of various embodiments. While the various aspects of the embodiments are presented in drawings, the drawings are not necessarily drawn to scale unless specifically indicated.

The phrases “connected to,” “coupled to,” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

As used herein, sludge has its common ordinary meaning. That is, sludge refers to any solid, semi-solid, or liquid waste material or precipitate. Sludge may be, but is not necessarily, generated in the treatment of wastewater. In many instances, the water content of sludge is substantial. One example of sludge is the output from a municipal water treatment plant. Municipal water treatment sludge may consist of solid matter fully or partially mixed with, or dissolved in, water. Another example may be sludge consisting of water and animal waste. Other examples of sludge may include output sludge from chemical processing, pharmaceutical processing, semiconductor processing, food processing, biomaterial processing, aluminum or ferric processing, other industrial processes, petro-chemical processing, electronic pulp and paper processing, textile processing, biomass processing, biogas processing, sludge produced in connection with power generation, and peat processing. Still further examples of sludges may include mining sludge, peat harvesting sludge, oil sludge, water purification sludge, animal slurry sludge, fruit waste sludge, fresh peat sludge, milled peat sludge, pulp and paper sludge, de-inking sludge, paper fibers sludge, food and beverage sludge, incineration generated sludge, algae sludge (including residue from biofuel production, sludges from other biofuel production methods, and recycled diaper waste sludge.

De-watering refers to processes designed at removing water from sludge. Many raw sludges are composed of as much as 98% moisture by weight. De-watering may be accomplished by a variety of means, including mixing coagulants and flocculants with the sludge and compressing the mixture. Such methods are generally only partially effective, that is, such techniques may only reduce the moisture content of the sludge to 80-85% moisture by weight. Attempts to further compress the treated sludge are generally ineffective, with the sludge tending to behave like a hydraulic fluid (binding and oozing) rather than the further compression removing additional water. Settling or drying techniques may also be employed to de-water sludge. It will be appreciated that “de-watering” is not limited to removing pure water (H₂O) from the sludge. Rather de-water involves the separation and removal of the liquid components of the waste, which may be composed of water as well as other material suspended in, dissolved in, or mixed with the water and/or other liquids.

In some instances sludge may be processed using physical or chemical treatment methods such as flocculation and/or coagulation, for example, When sludge undergoes a flocculating or coagulating step, the resultant partially de-watered sludge may consist of 1) “flocs,” or small lumps with a relatively high concentration of solid matter, and 2) water disposed between the flocs. The partially de-watered sludge can be understood as consisting of both “free water” or water disposed between flocs, and “entrapped water” or water that is within a floc.

As described in more detail below, a substantial amount of water may further be removed from sludge by mixing a blending material into the sludge then compressing the mixture. Sludge or semi-solid sludge cake comprising an output from another de-watering process (for example coagulating or flocculating then compressing, drying, or settling) may be used as an “input” sludge in this process. That is, sludge previously de-watered by other means can be further de-watered by mixing a blending material with the sludge and compressing the mixture. It will be appreciated that the sludge may be initially partially de-watered through any means known in the art.

Use of a blending material in conjunction with compression may result in a large amount of moisture being removed from the sludge, in some instances resulting in a moisture content of less than 20%. Again, by comparison, de-watering by coagulating or flocculating and compression generally results in a moisture content of around 80%-85%.

In some embodiments the sludge will also be partially or substantially de-odorized as a result of the de-watering process. In some sludges, the odor is associated more with liquid components of the sludge, not the solid matter suspended in the sludge. Thus, separation of the solid matter and the liquid waste may de-oderize the sludge.

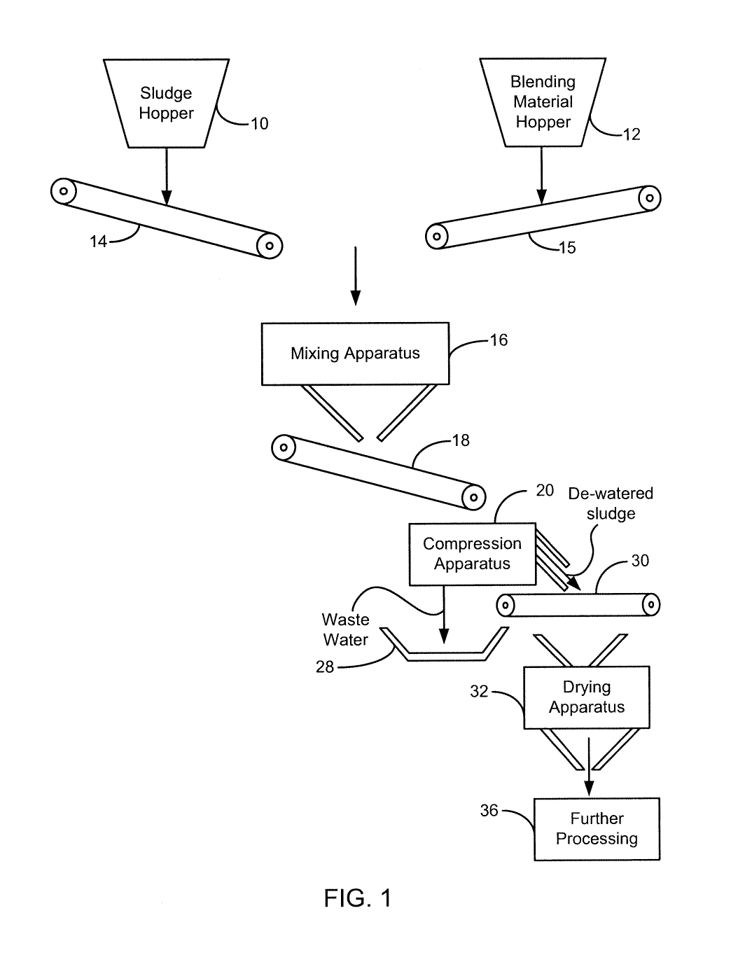

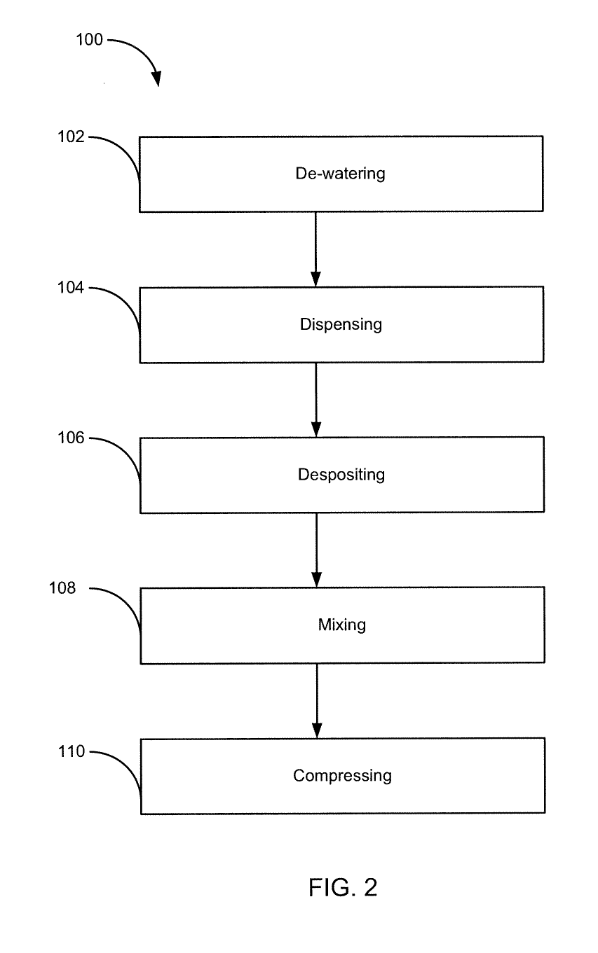

Referring generally to FIG. 1, which is a schematic illustration of one embodiment of a system for de-watering sludge, and FIG. 2, which is a flow diagram of an embodiment of a method of de-watering sludge, sludge may be de-watered by 1) mixing a blending material into the sludge and 2) compressing the mixture. Other steps or components may proceed or follow these two, as discussed in more detail below.

A number of blending materials are suitable for use de-watering sludge in this manner. Examples may include: cellulose-based materials, for example, wood shavings, newsprint, and milled peat. Further, trommel fines (the particles collected via trommell screens during the recycling of household waste), open-cell sponges, wood dust, and the dust collected during the machining of Medium Density Fiberboard (MDF), may also be utilized as blending materials. The blending material may further be treated with urea formaldehyde resin. In certain embodiments the blending material may be compressible.

In some embodiments the blending material and the sludge may be thoroughly mixed together in a substantially uniform manner. That is, the blending material may be evenly distributed throughout the sludge.

In certain embodiments, blending material may be mixed with sludge in about a 1:1 ratio, resulting in a mixture of sludge to blending material that is approximately 50% sludge and 50% blending material by weight. In other embodiments the ratio of blending material to sludge may be from about 1:1 to about 1:25. Further, the ranges of acceptable ratios of blending material to sludge may fall within this range, for instance from about 1:1 to about 1:10, about 1:1 to about 1:5, or about 1:1 to about 1:2.5. In some instances the desired ratio will at least partially depend on the water content of the sludge, the consistency of the sludge, or whether the sludge has previously undergone a prior de-watering process.

In certain embodiments, the blending material, substantially uniformly spread throughout the sludge, may essentially “coat” small lumps of sludge. Thus, it will be understood that “substantially uniformly spread” does not require that the blending material be perfectly distributed throughout the sludge, though in certain embodiments the blending material may be substantially perfectly distributed throughout the sludge. In some embodiments the sludge may consist of lumps or balls of sludge which become coated with blending material as the blending material is mixed into the sludge. These lumps or balls of sludge may or may not be “flocs” resulting from a flocculation step. The lumps may be of the same size and consistency as flocs if the sludge is treated with an initial flocculation (or coagulation) step or the flocs may also be broken up and reduced in size during the mixing of the blending material or at some other point in the process. Thus, the lumps of material may be smaller than the flocs. Unlike flocculants or coagulants, the blending material may be distributed throughout the sludge; while the former two agents tend to cause the solid matter in the sludge form lumps, the later agent may be substantially uniformly spread throughout the sludge, creating a composite material with a substantially uniform consistency.

In embodiments where the blending material coats small lumps of sludge, the blending material may prevent the clumps of sludge from directly interacting with each other during compression. Thus, instead of the sludge acting like a single mass or hydraulic fluid during compression, the blending material essentially separates the sludge into a collection of individual lumps. After compression these lumps, in some embodiments substantially spherical prior to compression, may be flattened out, resembling small discs coated with blending material.

In certain embodiments the blending material may be coal dust, ash, incinerator ash, sand, dried aluminum or ferric sludge, distillers dried grains, pulp and paper, or plant fibers or residue (such as, for example, nut shells, stalks, or other plant material). In other embodiments the blending material may consist of straw, bamboo, corncobs, banana fiber, greenwaste, or paper. It will be appreciated by those skilled in the art that this list is not exhaustive of possible blending materials. A variety of blending materials can be used without departing from the present disclosure. Therefore, without limiting the types of blending materials to those listed, specific embodiments utilizing specific blending materials are further described below. Further, the specific disclosure below is intended to supplement, not limit, the disclosure provided throughout. Thus, while specific combinations and ratios of blending materials are described below, each blending material may be used alone or in any combination with any other blending material in any ratio of sludge to blending material without departing from the scope and spirit of the present disclosure.

In one embodiment coal dust may be used as a blending material. In yet another embodiment, the coal dust may be particularly fine, in some instances each particle of coal dust being, on average, less than 100 microns. In other embodiments the coal dust may consist of particles with an average size of between about 2 microns and 1,000 microns. In some embodiments this range may be from about 200 microns to about 800 microns or from about 50 to about 500 microns. In certain embodiments, the coal dust is mixed with sludge at a 1:1 ratio resulting in a mixture of 50% coal dust and 50% sludge by weight. As previously stated, coal dust can also be combined with sludge at any ratio disclosed herein.

In some embodiments the blending material may act as a “filter” which tends to clean the water removed during compression. For example, in some instances, the water removed when coal is utilized as a blending material may be relatively clean in that much of the dissolved or suspended matter is removed.

It will be appreciated that, in some embodiments, combinations of blending materials may be used. For example, in some embodiments a blending material such as coal may be used in combination with another blending material such as pulverized wood fibers. Any blending material may be used in combination with any other blending material. Moreover, some embodiments may include combinations of more than two blending materials. Further, the composition of blending material need not be proportional; a combined blending material may consist of equal parts of multiple blending materials or unequal parts in any ratio. In other embodiments a single blending material may be utilized without combining it with other blending materials.

As indicated above, a variety of blending materials may be utilized without departing from the scope of the current disclosure. In certain embodiments the blending materials may have certain common physical or geometric characteristics. The listing of characteristics below is not intended to limit examples of potential blending materials herein disclosed nor to limit equivalent materials. Rather, certain blending materials have these characteristics and therefore certain equivalents may also have these characteristics. For example, in certain embodiments the blending material may consist of rigid particles. Further, the particles may be irregularly shaped and may contain one or more sharp angular edges. In such embodiments, the particles may contact each other at certain edges, but a substantial amount of empty space may remain when the particles are disposed next to each other. In some of these embodiments the particles may be characterized as granular or abrasive in nature due to the shape and rigidity of the particles.

For example, coal dust particles may be irregularly shaped and have one or more relatively sharp, angular edges. Due to the shape of these particles, they may not be readily “packed” next to each other. The irregular shapes and edges may prevent dense packing and result in a substantial amount of empty space between adjacent particles.

In embodiments where the particles are rigid, or angular, or both, the edges of the particles may essentially “pierce” cells or lumps of sludge during the compression step. Thus, during compression, some of the small, possibly spherical lumps of sludge may be further broken down or cut up. Thus, after compression when angular particles are use, the small lumps of sludge may or may not resemble discs or pancakes, rather some of the lumps may be further broken up. This breaking up of the small lumps of sludge may release a substantial amount of entrapped water. Further, in certain embodiments the blending material may tend to rupture the cell structures present in the sludge, releasing water trapped therein.

As will be appreciated by those skilled in the art, the blending material utilized in the process may impact the properties of the de-watered sludge. Thus, blending materials (or particular mixtures of blending materials) may be chosen based on desired properties of the de-watered sludge. In some instances, for example, the de-watered sludge may be subsequently used as a combustible fuel. In such embodiments, use of coal dust may be desirable to impact the combustion properties of the de-watered sludge. Similarly, other blending materials which have a high caloric value (or blending materials which may increase the specific caloric value of the mixture) may be utilized in order to improve the combustion properties of the de-watered sludge. In some instances such blending materials may increase the specific caloric value of the mixture due to the materials' properties when fired or co-cofired with the mixture.

In another embodiment ash (including, but not limited to, incinerator ash) may be selected as a blending material. Ash may be combined at a 1:1 ratio of sludge to blending material, or any other ratio disclosed herein. Similarly, sludge from aluminum or ferric processing may be dried and utilized as a blending material. As will be apparent to those skilled in the art, the aluminum or ferric sludge (to be used as a blending material) may be de-watered by any de-watering process, including the processes disclosed herein.

Straw, bamboo, corncobs, banana fiber, other types of greenwaste, algae, or paper may also be utilized as a blending material. In some instances renewable raw materials such as fast growing plants or straw may be used. In certain embodiments these blending materials will be pulverized prior to use as a blending material. In still another embodiment, pulverized straw, bamboo, corncobs, banana fiber, greenwaste, or paper may be further combined with fine sand or incinerator ash to create a combined blending material. In certain embodiments the combined blending material will be approximately 10% sand or ash.

Referring again to FIG. 1, a waste treatment system according to one embodiment of the present disclosure is shown. Sludge, which may be output from a wastewater treatment plant or other suitable producer of wastewater material, may initially be de-watered. The sludge may be collected in a sludge hopper 10. A suitable blending material to be mixed with the sludge may also be collected in a hopper 12.

As shown in FIG. 1, in one embodiment, the sludge and the blending material are dispensed from their respective hoppers 10, 12 to separate conveyors 14, 15. The sludge and the blending material may then be deposited into a suitable mixing apparatus 16. It will be understood by those skilled in the art, that the mixing apparatus 16 may be chosen from at least one of: a paddle mixer, screw mixer, agri feed mixer, and any mixing or blending device, as known in the art.

The mixing apparatus 16 may blend the sludge and the blending material together. In certain embodiments, the sludge and blending material may be thoroughly mixed to form a composite mixture. The mixing apparatus may be operable to mix the sludge and the blending material together at a slow rate, such that the mixture is folded together rather than beaten. The mixing can be performed rapidly or slowly without departing from the scope of this disclosure.

In one embodiment, the mixing process is performed by folding successive layers of sludge cake into contact with layers of the blending material. Further mixing is accomplished through the continued folding together of layers of the composite mixture, until the blending material of the composite mixture is substantially evenly spread.

As shown in FIG. 1, the composite mixture may exit the mixing apparatus 16 onto a conveyor 18. In the illustrated embodiment, the composite mixture is then delivered to a compression apparatus 20. The compression apparatus 20 may be chosen from any one of a belt press, a screw press, a plate press, a batch press, a filter press, a hydraulic press, or any compression device as known in the art. The compression apparatus 20 may be configured to allow the release of moisture from the contained mixture during compression.

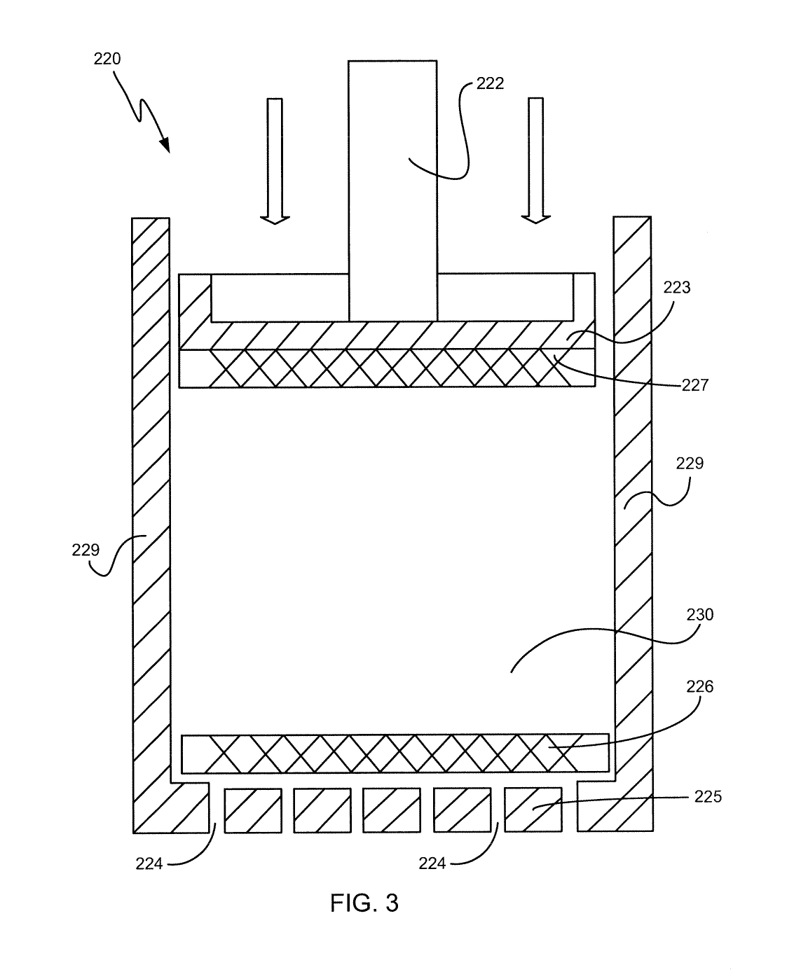

For example, the compression apparatus 20 may comprise a plate press having a conveyor located within the compression apparatus to firstly convey the composite mixture into the compression apparatus, and to secondly convey the composite mixture out of the compression apparatus after compression for further processing. The conveyor can be configured to allow the release of moisture from the contained mixture during compression. For example, in the case of a standard belt conveyor, the belt can be perforated to allow the moisture to drain through the conveyor belt. One or more of the plates used in the plate press can also be perforated, to allow the escape of moisture during compression. Further details of certain embodiments of compression apparatuses are provided below in connection with FIGS. 3-6.

Referring again to FIG. 1, the wastewater may then be collected in a suitable drain 28.

The resultant de-watered sludge may then be removed from the compression device 20 and brought by conveyor 30 to drying apparatus 32. The substantially de-watered resultant material is more easily dried due to the reduced levels of moisture present. The drying apparatus 32 can be one of a cyclonic dryer, a thermal dryer, an air dryer, a drum dryer, or any drying device as known in the art, for example the Tempest Drying System manufactured by GRRO Incorporated is one such device.

After drying, the resultant material may be substantially solid. In one embodiment the solid material exits the drying apparatus 32 and can then be further processed (method or apparatus) 36, depending on the application. For example, the further processing 36 can be a pelletizer, to convert the solid material into pellets for burning as fuel.

It will be understood that the resultant material (comprising de-watered sludge and blending material) can also be utilized as a substitute for the blending material to be mixed with the sludge in the mixing apparatus 16. In certain embodiments the resultant material produced by the process may be re-used as blending material for approximately three iterations.

Further, in one embodiment, further processing 36 the de-watered sludge and blending material can comprise an apparatus capable of separating the blending material from the de-watered sludge. For instance, an apparatus utilizing a vibrating screen may be employed to separate the blending material from the sludge. Another example of a separating mechanism may be an air separator which removes particles with a lower specific density by passing the particles over a jet of air. In one embodiment, blending material separated from de-watered sludge may be reused in the de-watering process described herein.

Referring again to the system generally, in one embodiment, mixing and compression can be performed on location at a waste treatment plant, with drying (and possibly pelletizing) performed at a remote location. In that case, the drying apparatus 32 in FIG. 1 may be replaced by a truck or suitable transport device that transfers the resultant material output from the compression apparatus 20 to another location where the drying and pelletizing stages are carried out.

Alternatively, the waste treatment apparatus itself may be provided as part of a mobile waste collection system. In that case, the hoppers 10, 12, mixing apparatus 16, and compression apparatus 20 are provided as part of a vehicle, for example on the rear of a truck, or on a truck trailer. The drying apparatus 32 may optionally be provided as part of the vehicle or, as above, the drying and further processing stages of the method may be performed at a remote location.

Use of this process or system, can result in a reduced moisture-level end product, with more manageable properties and a dry solids content approaching upwards of 80%. The end material may be substantially reduced in weight as opposed to conventional moisture extraction techniques, and is more easily transportable.

It will be appreciated by those skilled in the art that not every element described above and illustrated in the figures is necessary to the spirit of the disclosure provided herein. For example, it is within the scope of the present disclosure to provide an apparatus for mixing the sludge and blending material then compressing the mixture, omitting the other elements such as conveyers and hoppers herein described. It will further be appreciated by those skilled in the art that other elements can be added without departing from the scope and spirit of the present disclosure.

FIG. 2 is an illustration of one embodiment of a method for removing water from sludge 100. In the illustrated embodiment, the method 100 includes: obtaining de-watered 102 sludge comprising an output from a wastewater treatment system; dispensing 104 the sludge in a sludge hopper and dispensing a blending material in a recipient blending material hopper; depositing 106 the sludge and the blending material in a mixing device; mixing 108 the sludge and the blending material; and compressing 110 the sludge and the blending material to release moisture.

In one embodiment the process 100 further comprises the step of separating the blending material from the de-watered sludge. In still another embodiment, this separated blending material is reused to de-water more sludge.

Not all the disclosed steps are necessary in each embodiment of the current disclosure. For example, it is within the scope of the present disclosure to complete the steps of mixing and compressing while omitting some or all of the other disclosed steps. Further, additional steps can be added to the process without departing from the scope of the present disclosure.

It will also be appreciated by one skilled in the art that, in embodiments where de-watered sludge is used as in input in the disclosed process, the step of previously de-watering need not be performed in connection with the steps of the disclosed method. That is, de-watering by other means may be accomplished at the same location and by the same entity performing the disclosed method or at another location by another entity.

In one embodiment, the method 100 can improve de-watering of sewage sludge, both in undigested or undigested applications, and in a certain embodiments, in a digested application, for example, the sludge is pre-processed in a container where anaerobic digestion and processing occurs.

The method 100 has a wide variety of potential applications. For example, the method can be used with sludges in connection with the processing of: human, animal and the like waste; aluminum, ferrics and the like; pharmaceutical products; chemical products; semiconductor products; drugs and foods, such as in meat and milk processing, and the like. As will be appreciated by one skilled in the art, the disclosed process may be applied to any sludge, including but not limited to the specific examples contained in this disclosure.

FIGS. 3-6 illustrate various components of an embodiment of a system for de-watering sludge. It will be appreciated that these figures are illustrative in nature, showing the relative position of features of the components but not intended to exhaustively show all features. For example, each of the figures includes apertures placed on certain components. It will be appreciated that the illustrated apertures are not meant to show the precise number or location of these features, but rather to illustrate how these features function in relation to other components of the system. Further, the figures are not drawn to scale.

FIG. 3 is a cut-away front elevation view of one embodiment of a compression apparatus 220. In the illustrated embodiment the press has an upper plate 223 and a lower plate 225, and the lower plate contains a series of apertures 224 to allow drainage of moisture from the device 220. Further, as illustrated, a ram 222, may be coupled to the upper plate 223. The compression device 220 may also comprise side walls 229 which, in connection with the upper plate 223 and the lower plate 225, define a compression chamber 230.

As illustrated in FIG. 3, the apertures 224 are in the lower plate 225. As will be further discussed below, the upper plate 223 and/or the sidewalls 229 may also be configured with apertures. It will be appreciated that a variety of shapes and sizes of apertures 224 will allow an acceptable amount of water to flow away from the sludge during compression. In some embodiments the apertures comprise circular holes of about 5 mm spaced between 10 mm and 15 mm from center to center across substantially the entire surface containing apertures.

The compression apparatus 220 may work in conjunction with a conveyor belt 226. As illustrated, the cut-away view is perpendicular to the longitudinal direction of the conveyor belt 226. Thus, the conveyor belt 226 may deliver material from the front of the illustrated view, toward the back of the illustrated view.

The conveyor belt 226, may be comprised of a porous or semi porous material which may act as a filter for water released from the sludge during compression. In other words, the conveyor belt 226 may allow water to pass through, but not sludge, thereby at least partially preventing sludge from blocking the apertures 224. Thus, in embodiments where the upper plate 223 contains apertures, a filter material 227 may be coupled to the lower surface of the upper plate 223. In some embodiments, this filter material 227 may be consist of the same material as the conveyor belt 226. The filter material 227 may alternatively be made from any porous material that allows through passage of liquids and minimizes the flow of solids, for example, such as cotton. Further, the upper surface of the lower plate 225 may also be coupled to a filter material in some embodiments. In embodiments where the side walls 229 are configured with apertures, filter material may also be coupled to the side walls 229.

Initially, the ram 222 may be maintained in an ‘at rest’ position at the top of the plate press. In operation, the composite mixture may be supplied to the interior chamber 230 of the plate press. During compression, the ram 222 may be driven in a downwards direction, towards the apertures 224. As the composite material is compressed, moisture is forced from the mixture, in the form of wastewater. The expelled wastewater may pass through the filter material 226, and exit the plate press through the apertures 224.

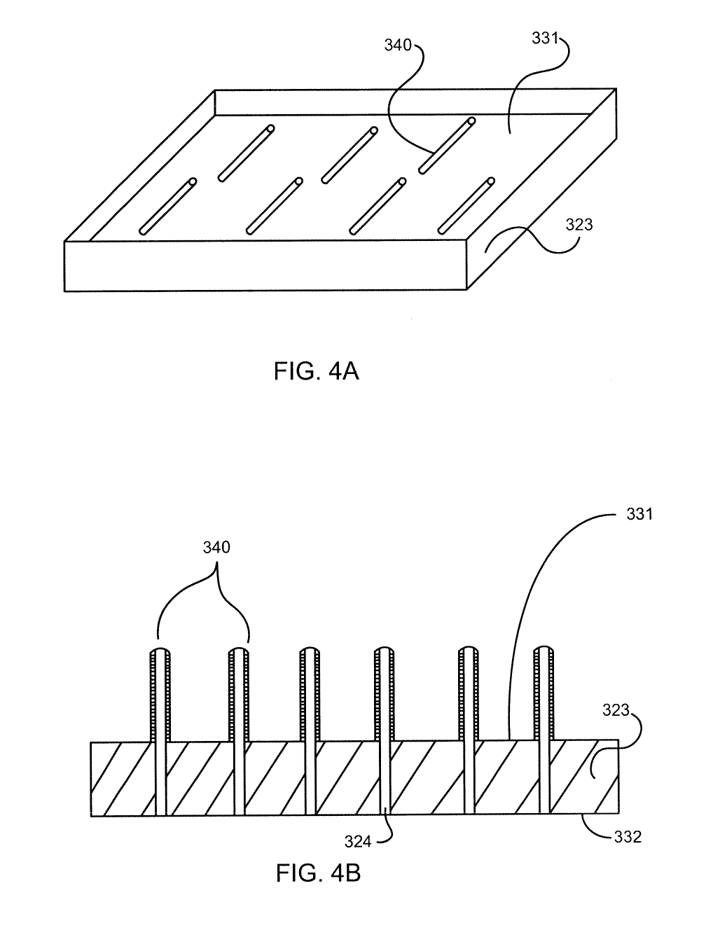

Referring now to FIG. 4A, which is a perspective view of one embodiment of a upper plate 323 and FIG. 4B which is a cut-away front elevation view of the upper plate 323 of FIG. 4A. FIGS. 4A and 4B include features also found in the embodiment of FIG. 3. Accordingly, like features are designated with like reference numerals, with the leading digits incremented to “3.” Relevant disclosure set forth above regarding similarly identified features thus may not be repeated hereafter. Moreover, specific features of the embodiment of FIGS. 4A and 4B may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the apparatus of FIGS. 4A and 4B. Any suitable combination of the features and variations of the same described with respect to the apparatus of FIG. 3 can be employed with the apparatus of FIGS. 4A and 4B, and vice versa. This pattern of disclosure applies equally to further embodiments depicted in subsequent figures and described hereafter.

The upper plate has an upper surface 331 and a lower surface 332 and apertures 324. In the illustrated embodiment, the apertures are further be configured with tubes 340 coupled to the upper surface 331 of the upper plate. The circumference of each tube 340 is coupled to the outside diameter one of the apertures 324. The tubes 340 may be relatively short and disposed substantially perpendicular to the upper surface 331 of the plate. In the illustrated embodiments, water forced through the apertures 324 in the upper plate will flow into the tube 340. When the volume of water in the tube 340 exceeds the volume of the tube itself, the water may flow over the top of the tube 340 and out through a drainage mechanism. The short sections of tube 340 may prevent water lying on the upper surface 331 of the plate after compression from flowing back through the apertures 324 toward the sludge after compression.

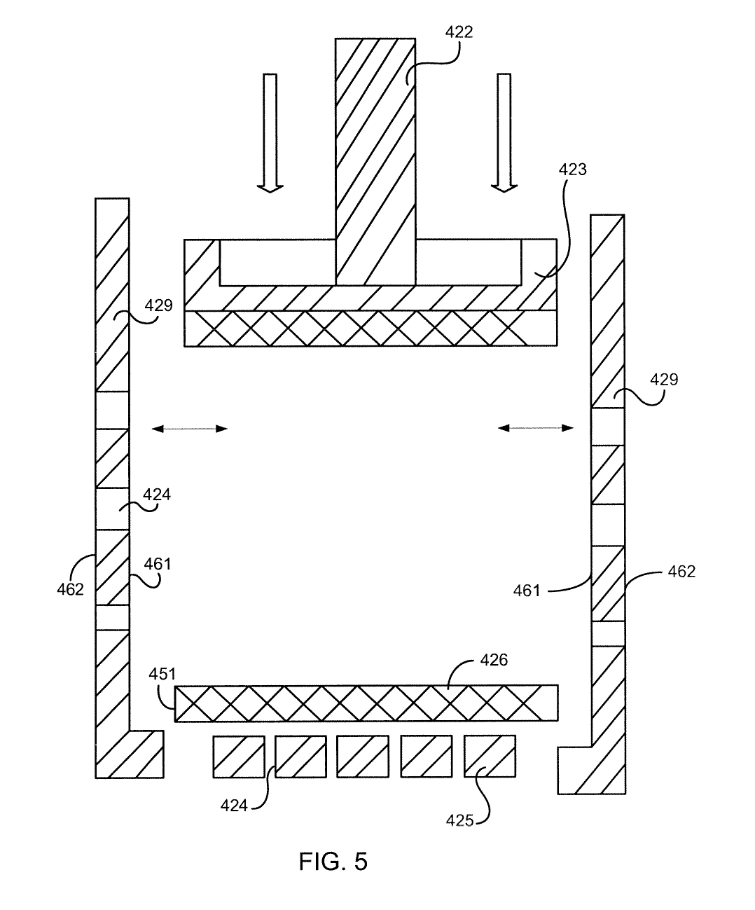

FIG. 5 illustrates a cut-away front elevation view of an embodiment of a compression apparatus which includes sidewalls 429. The sidewalls 429 may have an inner surface 461 and an outer surface 462. The illustrated embodiment also includes a ram 422, an upper plate 423, a bottom plate 425, apertures 424, and a conveyor belt 426 which has two lateral sides 451. The sidewalls 429 may be fixed or configured to move toward or away from the lateral sides 451 of the conveyor as indicated by the arrows. In certain embodiments the sidewalls 429 will be disposed adjacent to the lateral sides 451 of the conveyor during compression, forming a compression chamber in connection with the upper plate 423 and lower plate 425. After compression the sidewalls may move away from the lateral sides 451 of the conveyor belt 426 to more freely allow the conveyor belt to advance the de-watered sludge in the longitudinal direction of the conveyor belt 426 and minimize the amount of material that becomes lodged against the sidewalls 429. The sidewalls 429 may or may not be configured with apertures 424 and/or a filter layer.

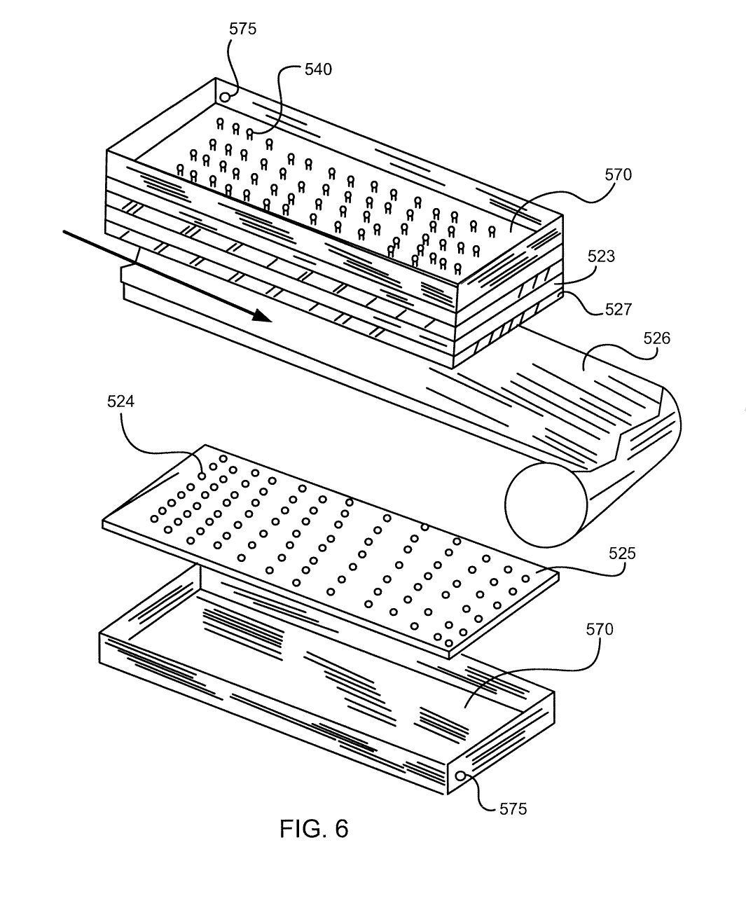

FIG. 6 is an exploded perspective view of part of a compression apparatus. The illustrated view includes an upper plate 523, a lower plate 525, apertures 524 in the lower plate 525 and the upper plate 523, tubes 540 coupled to the upper surface of the upper plate 523, an upper filter layer 527 on the lower surface of the upper plate, and a conveyor belt 526. The conveyor belt 526 may advance sludge mixed with blending material into the compression chamber in the direction of the arrow. After compression, the conveyor belt 526 may also convey the de-watered sludge from the compression chamber while simultaneously bringing more sludge and blending material mixture into the compression chamber. During compression, water pressed out of the sludge may flow through the apertures into spaces 570 below the lower plate and above the upper plate, then out through a suitable drainage pathway 575. It will be appreciated that a variety of drainage systems such as that designated by numeral 570 and 575 may be used.

It will be understood that the above configuration for the plate press may be adapted as required for the other types of compression apparatus as mentioned, i.e. that the compression apparatus are configured to allow the escape of wastewater during compression, while retaining the solid material.

Referring now to the compression stage generally, in one embodiment, compression may generally occur at pressures between about 10 psi and about 10,000 psi, such as from about 100 psi to about 5,000 psi, about 150 psi to about 2,500 psi, and about 200 psi to about 2,000 psi. A large amount of wastewater may be expelled from the mixture at lower pressures, but if compression is maintained at the specified levels, the majority of wastewater may be substantially eliminated from the mixture.

In some embodiments, the pressure is applied gradually, and is maintained for a period of time. For example, for an amount of composite mixture having a width of approximately 101.6 cm (40 inches) and a depth of approximately 101.6 cm (40 inches), the period of time for compression to substantially ensure maximum de-watering may be 30 seconds. It will be appreciated that the type of blending material used may impact the period of time for which compression is effective. For example, when certain angular particles are used substantial de-watering may be achieved with around 15 seconds of compression. In other embodiments the time of compression may be from about 10 seconds to about 200 seconds, for example from about 10 seconds to 100 seconds or about 15 seconds to 30 seconds. It will be appreciated that the nature and type of sludge being compressed and the nature and type of blending material used may affect the optimal length of compression.

The wastewater expelled from the composite mixture can then be returned to a wastewater treatment plant for further processing and refinement.

The presence of the blending material in the composite mixture may allow for a greater proportion of moisture to be squeezed from the sludge. Expelling the moisture from the composite mixture may produce a substantially de-watered resultant material, with a moisture content of about 20%.

While specific embodiments of a method and system for waste water treatment have been illustrated and described, it is to be understood that the disclosure provided is not limited to the precise configuration and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

1. A method for removing water from sludge comprising the steps of:
mixing the sludge and at least one blending material such that the blending material is distributed throughout the sludge in a substantially uniform manner to form a mixture; and
compressing the mixture of sludge and blending material,
wherein the blending material is composed of rigid particles.

2. The method of claim 1 wherein the blending material is composed of particles having at least one angular, sharp edge.

3. The method of claim 1 wherein the blending material is at least partially composed of at least one of: coal particles, ash particles, sand, dried ferric sludge, dried aluminum sludge, and metal shavings.

4. The method of claim 1 wherein the average particle size of the blending material is between 2 and 1,000 microns.

5. The method of claim 4 wherein the average particle size of the blending material is between 50 and 500 microns.

6. The method of claim 1 wherein the particles are abrasive.

7. The method of claim 1 wherein the weight ratio of sludge to blending material is from about 1:1 to about 8:1.

8. The method of claim 7 wherein the weight ratio of sludge to blending material is from about 1:1 to about 3:1.

9. The method of claim 1 wherein the mixture is compressed at a pressure between about 10 psi and 1,500 psi.

10. The method of claim 1 wherein the sludge is at least partially de-odorized as a result of the process.

11. A method for removing water from sludge comprising the steps of:
mixing the sludge and at least one blending material such that the blending material is distributed throughout the sludge in a substantially uniform manner to form a mixture; and
compressing the mixture of sludge and blending material,
wherein the blending material is composed of particles which do not substantially compress under pressure.

12. The method of claim 11 wherein the blending material is composed of particles having at least one angular, sharp edge.

13. The method of claim 11 wherein the blending material is at least partially composed of at least one of: coal particles, ash particles, sand, dried ferric sludge, dried aluminum sludge, and metal shavings.

14. The method of claim 11 wherein the average particle size of the blending material is between 2 and 1,000 microns.

15. The method of claim 14 wherein the average particle size of the blending material is between 50 and 500 microns.

16. The method of claim 11 wherein the particles are abrasive.

17. The method of claim 11 wherein the weight ratio of sludge to blending material is from about 1:1 to about 8:1.

18. The method of claim 17 wherein the weight ratio of sludge to blending material is from about 1:1 to about 3:1.

19. The method of claim 11 wherein the mixture is compressed at a pressure between about 10 psi and 1,500 psi.

20. The method of claim 11 wherein the sludge is at least partially de-odorized as a result of the process.

21. A method for removing water from sludge comprising the steps of:
mixing the sludge and at least one blending material such that the blending material is distributed throughout the sludge in a substantially uniform manner to form a mixture; and
compressing the mixture of sludge and blending material,
wherein the blending material is composed of irregularly shaped, angular particles, wherein the shape of the particles is such that when the particles are disposed next to each other such that edges of the particles contact adjacent particles, there is a substantial amount of empty space remaining between the particles.

22. The method of claim 21 wherein the blending material is composed of rigid particles.

23. The method of claim 21 wherein the blending material is composed of particles which do not substantially compress under pressure.

24. The method of claim 21 wherein the blending material is at least partially composed of at least one of: coal particles, ash particles, sand, dried ferric sludge, dried aluminum sludge, and metal shavings.

25. The method of claim 21 wherein the average particle size of the blending material is between 2 and 1,000 microns.

26. The method of claim 25 wherein the average particle size of the blending material is between 50 and 500 microns.

27. The method of claim 21 wherein the particles are abrasive.

28. The method of claim 21 wherein the weight ratio of sludge to blending material is from about 1:1 to about 8:1.

29. The method of claim 28 wherein the weight ratio of sludge to blending material is from about 1:1 to about 3:1.

30. The method of claim 21 wherein the mixture is compressed at a pressure between about 10 psi and 1,500 psi.

31. The method of claim 21 wherein the sludge is at least partially de-odorized as a result of the process.

32. A system for removing water from sludge, comprising:
a mixing apparatus configured to uniformly mix sludge with a blending material into a mixture,
a compression apparatus configured to compress the mixture of sludge and the blending material,
a delivery apparatus configured to move the mixture from the mixing apparatus to the compression apparatus.

33. The system of claim 32 wherein the blending material is composed of irregularly shaped, angular particles, wherein the shape of the particles is such that when the particles are disposed next to each other such that edges of the particles contact adjacent particles, there is a substantial amount of empty space remaining between the particles.

34. The system of claim 32 wherein the blending material is stored in a first hopper and the sludge stored in a second hopper prior to mixing.

35. The system of claim 34 wherein the blending material is dispensed from the first hopper, and the sludge dispensed from the second hopper, directly into the mixing apparatus.

36. The system of claim 35 wherein at least one of the blending material and the sludge is dispensed from a hopper by an automated control process.

37. The system of claim 32 wherein the delivery apparatus comprises a conveyor belt.

38. The system of claim 37 wherein the conveyor belt delivers the mixture to the compression apparatus and conveys the mixture out of the compression apparatus after compression.

39. The system of claim 32 wherein the compression apparatus comprises a plate press.

40. The system of claim 39 wherein the delivery device comprises a conveyor belt which delivers the mixture to the compression apparatus and conveys the mixture out of the compression apparatus after compression.

41. The system of claim 40 wherein the conveyor belt is configured to allow water to pass through the belt during compression.

42. The system of claim 41 wherein the plate press has a lower plate with a plurality of holes configured to allow water to pass through the lower plate during compression.

43. The system of claim 42 wherein the plate press has an upper plate with a plurality of holes configured to allow water to pass through the upper plate during compression.

44. The system of claim 43 wherein the upper plate has an upper surface and a length of tube is coupled to an outside diameter of at least one of the holes at the upper surface of the plate, the tube disposed substantially perpendicular to the upper surface of the plate and configured to prevent water resting on the upper surface of the plate from passing through the hole coupled to the tube.

45. The system of claim 44 wherein each hole is configured with a length of tube.

46. The system of claim 39 wherein the plate press has a compression surface with essentially four sides, wherein the compression surface is bordered on at least one side by a sidewall.

47. The system of claim 46 wherein at least one of the sidewalls is configured to move away from the center of the compression surface after compression.
